(19) United States
(12) Patent Application Publication
(10) Pub. No.: US 2018/0145523 A1
(43) Pub. Date: May 24, 2018

(54) Network-Operable Battery Charger, Charging System, and Hand-Held Machine Tool

(71) Applicant: Hilti Aktiengesellschaft, Schaan (LI)

(72) Inventor: Markus Hunger, Augsburg (DE)

(73) Assignee: Hilti Aktiengesellschaft, Schaan (LI)

(21) Appl. No.: 15/568,763

(22) PCT Filed: Apr. 22, 2016
(86) PCT No.: PCT/EP2016/059016

§ 371 Date: Oct. 23, 2017

(30) Foreign Application Priority Data
Apr. 24, 2015 (EP) 15165010.8

(51) Int. Cl. H02J 7/00; B25D 11/06

(52) U.S. Cl. CPC H02J 7/0045; H02J 7/0013; B25D 2211/06; B25D 11/06; H02J 7/0003

(57) ABSTRACT

A battery charger is disclosed. The battery charger includes a charger housing which has a main charging interface for connecting a main tool battery of a hand-held machine tool. The main charging interface is arranged on a connection side of the charger housing. The battery charger has at least one secondary charging interface arranged on the connection side of the charger housing. The secondary charging interface is configured to be displaceable between a charging position and a rest position so that a secondary tool battery can be connected to the secondary charging interface when the secondary charging interface is in the charging position.

This application claims the priority of International Application No. PCT/EP2016/059016, filed Apr. 22, 2016, and European Patent Document No. 15165010.8, filed Apr. 24, 2015, the disclosures of which are expressly incorporated by reference herein.

### BACKGROUND AND SUMMARY OF THE INVENTION

The present invention relates to a network-operable battery charger comprising a charger housing which has a main charging interface for connecting a main tool battery of a hand-held machine tool, the main charging interface being arranged on a connection side of the charger housing. The present invention also relates to a charging system comprising a network-operable battery charger and a main tool battery. The present invention further relates to a hand-held machine tool, in particular a jackhammer or a combination hammer comprising a tool housing in whose battery receiving recess a main supply interface for connecting a main tool battery is arranged.

The object of the present invention is to indicate a network-operable battery charger, a charging system as well as a hand-held machine tool, which can be used in a versatile manner. With regard to the battery charger, the object is achieved by the battery charger comprising at least one secondary charging interface arranged on the connection side of the charger housing, which is configured to be displaceable between a charging position and a rest position in such a way that a secondary tool battery can be connected to the secondary charging interface when the secondary charging interface is in the charging position.

The main tool battery and secondary tool battery can be different types, in particular the main tool battery and secondary tool battery can be configured and/or intended to operate hand-held machine tools of different types.

The invention includes the knowledge that main tool batteries and second tool batteries, in particular when they are different types, could not be charged hitherto via one and the same battery charger. It is thus, for example, impossible using the battery chargers of the prior art to charge both a main tool battery of a new generation and a secondary tool battery of an older generation on one and the same connection side of the battery charger since they are typically coded in a mechanically different manner or comprise mechanically different configurations which are incompatible with each other. A secondary tool battery can now advantageously be charged on the secondary charging interface by the network-operable battery charger according to the invention, and the secondary charging interface is displaceable between the charging position and the rest position. The advantage is that batteries of different types can be charged on one and the same connection side of the charger housing whereby the battery charger can be used in a versatile manner.

In a preferred configuration, the main charging interface is mechanically locked against the connection of the main tool battery when the secondary charging interface is in the charging position. Charging of a battery type not suitable for connection to the secondary charging interface can thus already be effectively prevented, whereby the battery charger can be particularly safely operated.

Alternatively or additionally, the main charging interface can be mechanically released for connecting the tool battery when the secondary charging interface is in the rest position. The secondary charging interface is preferably mechanically locked against the connection of the secondary tool battery when the secondary charging interface is in the rest position. In other words, the network-operable battery charger is preferably designed in such a way that either only one main tool battery or a secondary tool battery can be connected and/or charged on the connection side of the charger housing.

In a particularly preferred configuration, the main charging interface is configured as a charging socket (female embodiment). The secondary charging interface can be configured as a blade displaceable between the charging position and the rest position, which protrudes from the connection side of the charger housing in the charging position (male embodiment). The secondary charging interface configured as the displaceable blade is, in its rest position, preferably substantially flush-mounted with the connection side of the charger housing, or in any case not protruding from the charger housing. The battery charger preferably comprises a charging electronics, which is arranged and configured inside the charger housing, in order to charge the main tool battery to be connected via the main charging interface using a main charging configuration.

The charging electronics can also be configured to charge the secondary tool battery to be connected via the secondary charging interface using a secondary charging configuration. A respective charging configuration preferably comprises a predetermined voltage strength, a maximum charge quantity, and/or additional charging parameters. The charging electronics can thus for example be configured to charge a main tool battery with a nominal voltage of 36 volts and/or to charge a secondary tool battery with a nominal voltage of 14 volts or 22 volts. Other voltage configurations are possible.

The secondary charging interface is preferably electrically connected to the same electronics as the main charging interface. A particularly simple and cheap construction of the battery charger thus results.

In one particularly preferred configuration, the battery charger comprises at least one sensor which is configured and arranged to sense whether the secondary charging interface is in the charging position or the rest position. The sensor can, for example, be an optical sensor or mechanical sensor, which is preferably arranged in proximity to the connection side of the charger housing. A plurality of sensors can be provided.

In the context of increased operational safety, but also increased ease of use, it has been found to be advantageous to configure the charging electronics to switch the charging configuration depending on a sensor value of the sensor. The secondary charging interface can, for example, be configured to be displaceable between the charging position and the rest position by means of a manually operable slider. The sensor can, for example, be mechanically coupled to the slider so that a charging configuration intended for the main tool battery is activated when the secondary charging interface in the rest position. On the other hand, a charging configuration intended for charging the secondary tool battery is, for example, activated when the secondary charging interface, as sensed by the sensor, is in the charging position.

The main charging interface configured for receiving the main tool battery and the secondary charging interface, which can be connected to a secondary tool battery, are preferably coded mechanically differently to each other, and the main tool battery and secondary tool battery are preferably different types.

The main tool battery preferably comprises a main battery interface corresponding to the main charging interface. Moreover, the secondary tool battery preferably comprises a secondary battery interface corresponding to the secondary charging interface of the battery charger. The battery charger can comprise one, two, or a plurality of secondary charging interfaces. The battery charger preferably comprises precisely one secondary charging interface. The battery charger can comprise precisely two secondary charging interfaces.

With regard to the charging system, the object is achieved by a previously-described, network-operable battery charger and at least one main tool battery for whose connection the main charging interface of the network-operable battery charger is configured and/or with at least one secondary tool battery for whose connection the secondary charging interface is configured.

With regard to the hand-held machine tool, the object is achieved by a secondary supply interface for connecting a secondary tool battery, if required, being arranged in the receiving recess, the secondary supply interface being configured to be displaceable between a supply position and a rest position in such a way that the secondary tool battery can be connected to the secondary supply interface when the secondary supply interface is in the supply position. The hand-held machine tool, according to the invention, can be further developed in a corresponding manner to the previously-described battery charger. For example, the secondary supply interface is preferably configured as a charging socket so that a secondary charging interface of the battery charger, which is configured as a displaceable blade, can be inserted into this charging socket.

Additional advantages emerge from the following description of the figures. Different exemplary embodiments of the present invention are represented in the figures. The figures, the description, and the claims include numerous features in combination. The person skilled in the art will expediently also consider the features individually and combine them to form reasonable additional combinations.

Identical and similar components are labelled with the same reference numerals in the figures.

### BRIEF DESCRIPTION OF THE DRAWINGS

FIG. 1 is a schematic representation of a network-operable battery charger, according to the prior art;

FIG. 2 is a schematic representation of a first exemplary embodiment of a network-operable battery charger, according to the invention;

FIG. 3 is a schematic representation of the battery charger from FIG. 2, to which a main tool battery is to be connected;

FIG. 4 is a schematic representation of the battery charger from FIG. 2, to which a secondary tool battery is to be connected;

FIG. 5 is a schematic representation of a second exemplary embodiment of a network-operable battery charger, according to the invention in a sectional representation;

FIG. 6 is a schematic representation of the battery charger from FIG. 5, to which a main tool battery is to be connected;

FIG. 7 is a schematic representation of the battery charger from FIG. 5, to which a first secondary tool battery is to be connected;

FIG. 8 is a schematic representation of the battery charger from FIG. 5, to which a second secondary tool battery is to be connected; and

FIG. 9 is a schematic representation of a hand-held machine tool, according to the invention.

### DETAILED DESCRIPTION OF THE DRAWINGS

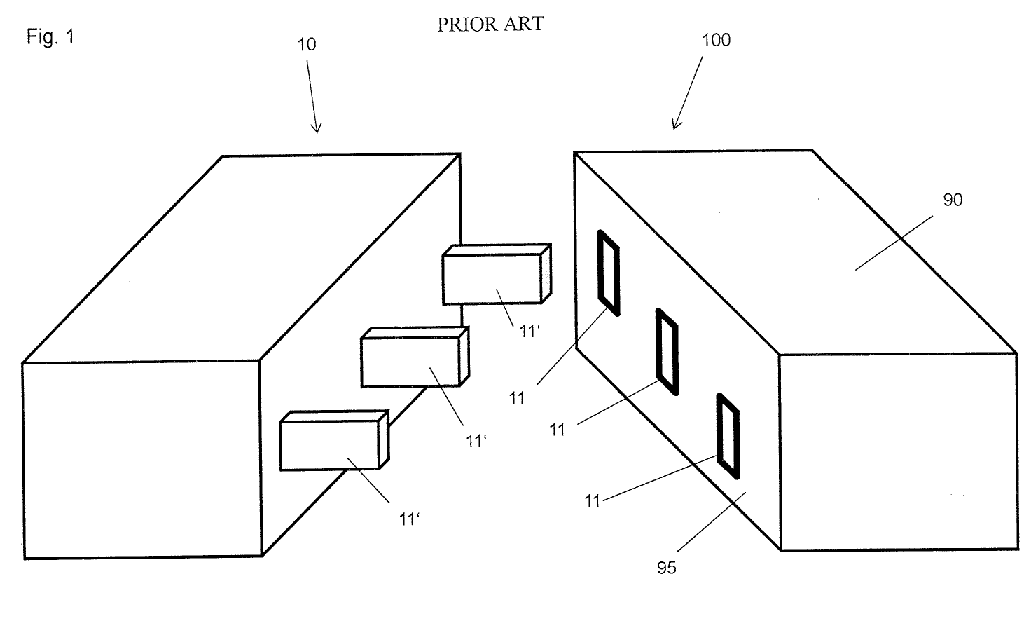

FIG. 1 shows a network-operable battery charger 100 according to the prior art on the right-hand side. The battery charger 100 comprises a charger housing 90 that comprises a main charging interface 11 for connecting a main tool battery 10, shown on the left-hand side. In the exemplary embodiment represented, the main charging interface 11 is configured in the form of three charging sockets, which are arranged on a connection side 95 of the charger housing.

The main tool battery 10 on the left-hand side of FIG. 1 comprises a main battery interface 11′, which corresponds to the main charging interface 11 of the battery charger 100, and in the present example is configured by three blades protruding rigidly from a surface of the main tool battery 10. In order to connect the main tool battery 10 to the battery charger 100 of the prior art, the main battery interface 11′ is inserted into the corresponding main charging interface 11 of the battery charger.

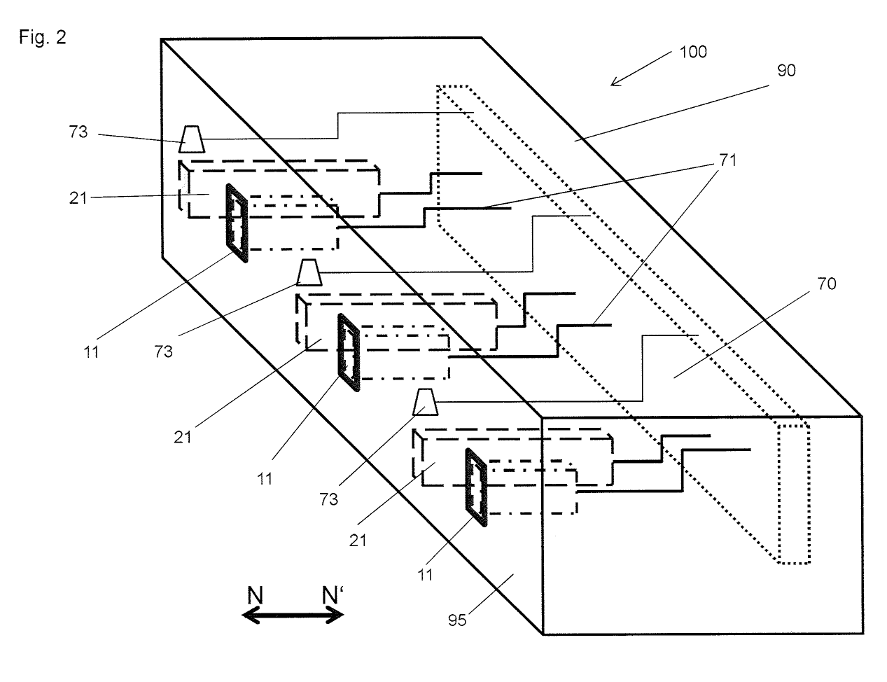

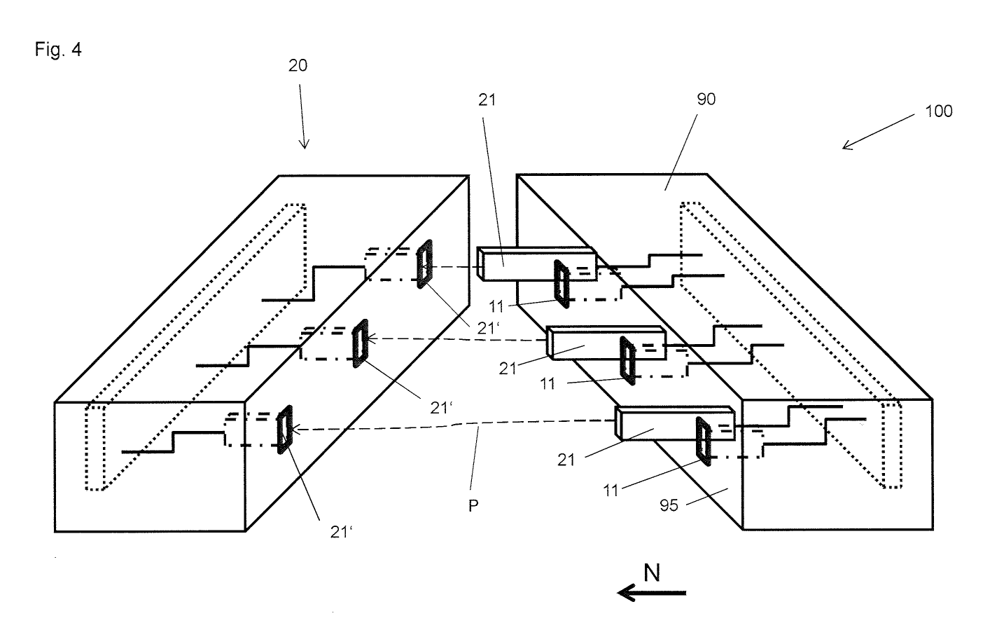

A battery charger 100, according to the invention in FIG. 2, comprises a secondary charging interface 21 in addition to the main charging interface 11, which is provided on the connection side 95 of the charger housing 90 in the form of three charging sockets. This secondary charging interface 21 is also arranged on the connection side 95 of the charger housing. In the represented exemplary embodiment, the secondary charging interface 21 is provided by three displaceable blades. The secondary charging interface 21 in the form of the three blades is displaceable; more precisely, it is configured so as to be displaceable between a charging position N and a rest position N′. The rest position N′ of the secondary charging interface is represented in FIG. 2, in which the three blades are located substantially flush-mounted with the connection side 95 of the charger housing 90. Reference is made to FIG. 4 with regard to the charging position N of the secondary charging interface 21.

As is also discernible from FIG. 2, the battery charger 100 comprises a charging electronics 70 which is arranged inside the charger housing. The charging electronics 70 is connected via respective connection cables 71 both to the main charging interface 11 and to the secondary charging interface 21.

In the present exemplary embodiment, the battery charger 100 comprises three sensors 73 which are configured and arranged to sense whether the secondary charging interface 21 in the form of the three slidable blades is in the charging position N or the rest position N′. In the representation of FIG. 2, the secondary charging interface is in the rest position N′, more precisely the three displaceable blades are arranged inside the charger housing 90 such that they do not protrude from the connection side 95. This is indicated by the dotted representation of the secondary charging interface 21. In contrast to this, the main charging interface 11 in the form of the three charging sockets is not arranged displaceably in the charger housing 90 or on its connection side 95 which is symbolized by the dotted line.

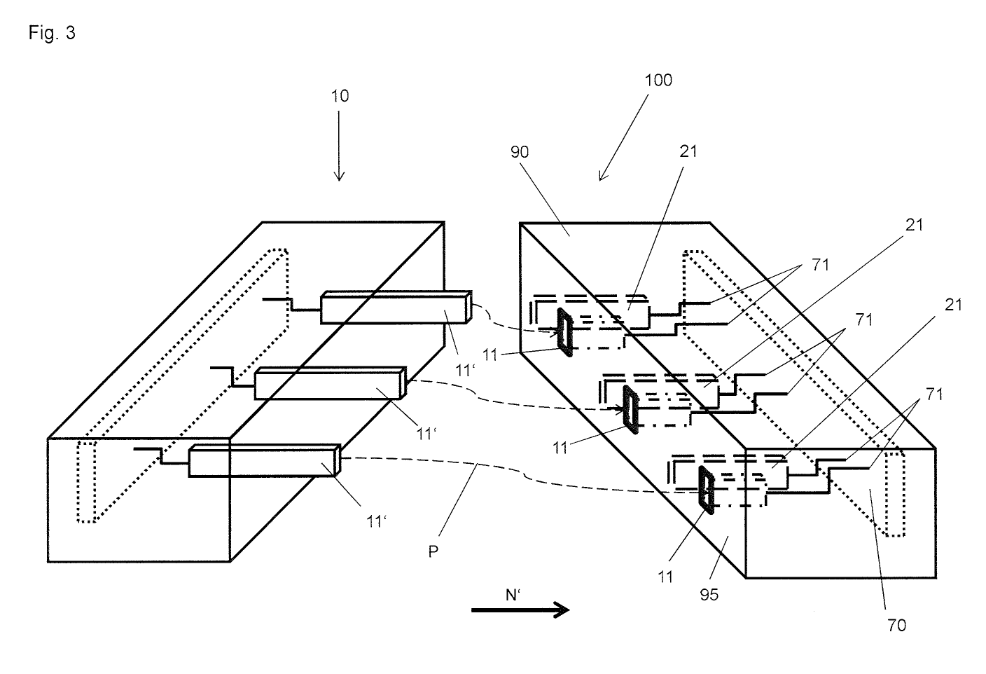

FIG. 3 represents how a main tool battery 10 is connected to the battery charger 100 along a motion path P. As the secondary charging interface 21 is in the rest position N′, the connection side 95 for connecting the main tool battery 10 is released. In other words, the main tool battery 10 can be inserted with its main battery interface 11′ configured as three blades into the corresponding main charging interface 11 configured as three charging sockets, since the secondary charging interface 21 configured as three blades does not protrude from the connection side 95 of the charger housing 90.

FIG. 4 now shows the case where a secondary tool battery 20, which is coded mechanically differently to a main tool battery 10 (see FIG. 3), is connected to the battery charger 100. In the represented exemplary embodiment, the secondary tool battery 20 comprises a secondary battery interface 21′ which, as shown, is configured as sockets rigidly arranged on a surface of the secondary tool battery 20. In the present case, precisely three sockets are configured.

The battery charger 100 is represented on the right-hand side of FIG. 4, and the secondary charging interface 21 is in the charging position N. As can be discerned, the three displaceable blades, which form the secondary charging interface 21 of the battery charger 100, protrude from the connection side 95 of the charger housing 90. As a result, the secondary tool battery 20 can be connected by its corresponding secondary battery interface 21′ on the secondary charging interface 21. Likewise, since the secondary charging interface 21 in the form of three displaceable blades protrudes from the connection side 95 of the charger housing 90, the main charging interface 11 is mechanically locked against the connection of the main tool battery 10 (see FIG. 3).

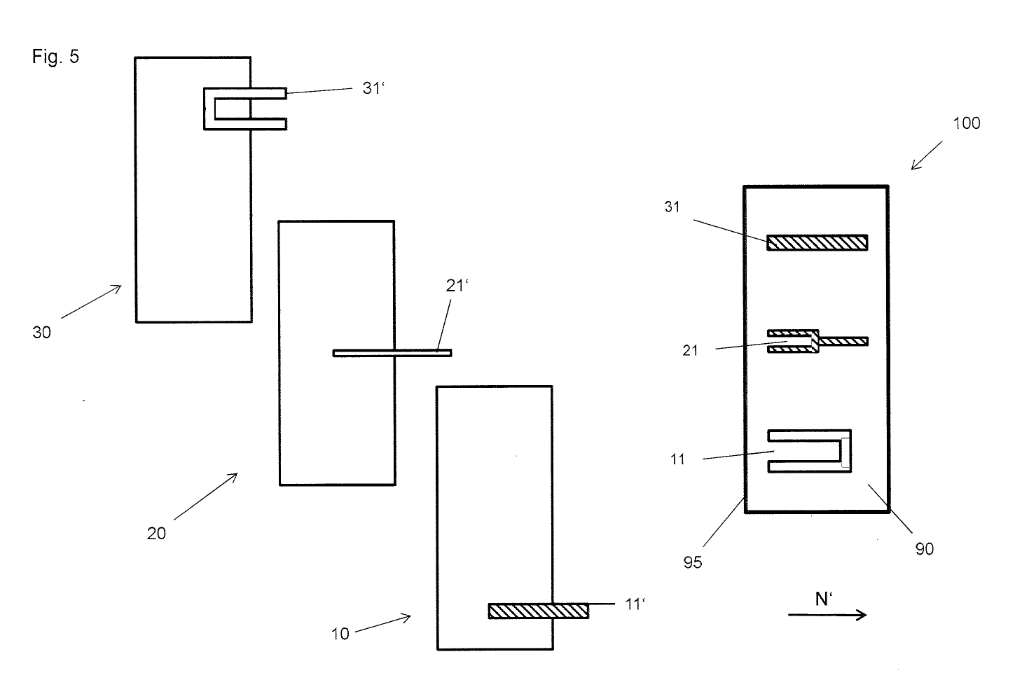

FIG. 5 schematically shows a sectional representation and top view of a second exemplary embodiment of a battery charger 100 according to the invention. The battery charger 100 comprises a main charging interface 11, as well as a first secondary charging interface 21 and a second secondary charging interface 31. In the present case, both the main charging interface 11 and the secondary charging interface 21, 31 are displaceable between a charging position N (not represented) and a rest position N′ (represented).

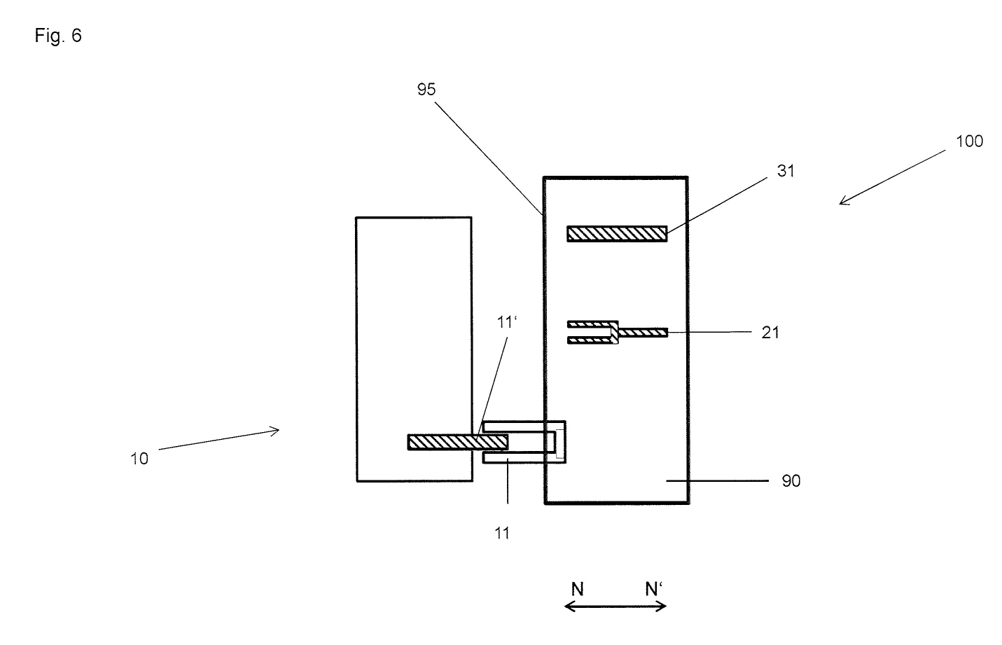

As can be discerned from FIG. 6, the main charging interface 11 is configured in the present case as a displaceable charging socket and represented in FIG. 6 in the charging position N. A main tool battery 10, which comprises a main battery interface 11′ configured as a rigid blade, can thus be connected to the battery charger 100 and therefore charged.

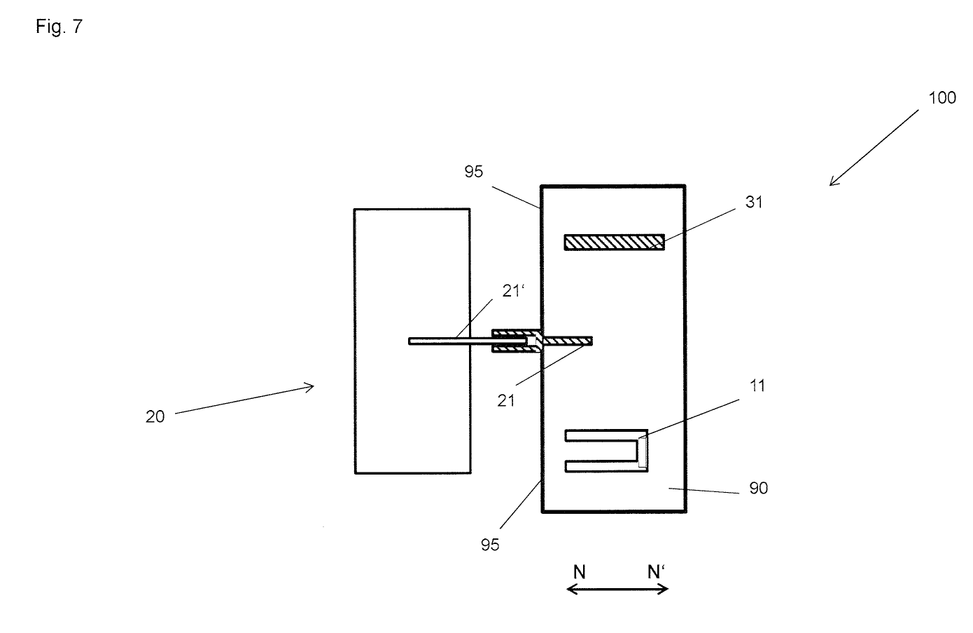

The main charging interface 11 just described in regard to FIG. 6 is represented in FIG. 7 in a rest position N′ that means that it is arranged inside the charger housing 90 or in any case does not protrude from the connection side 95. A first secondary charging interface 21 configured as a displaceable charging socket is shown in FIG. 7 in the charging position N so that a first secondary tool battery 20, which comprises a first secondary battery interface 21′ in the form of a blade corresponding to the first secondary charging interface 21, can be connected to the battery charger 100 and charged.

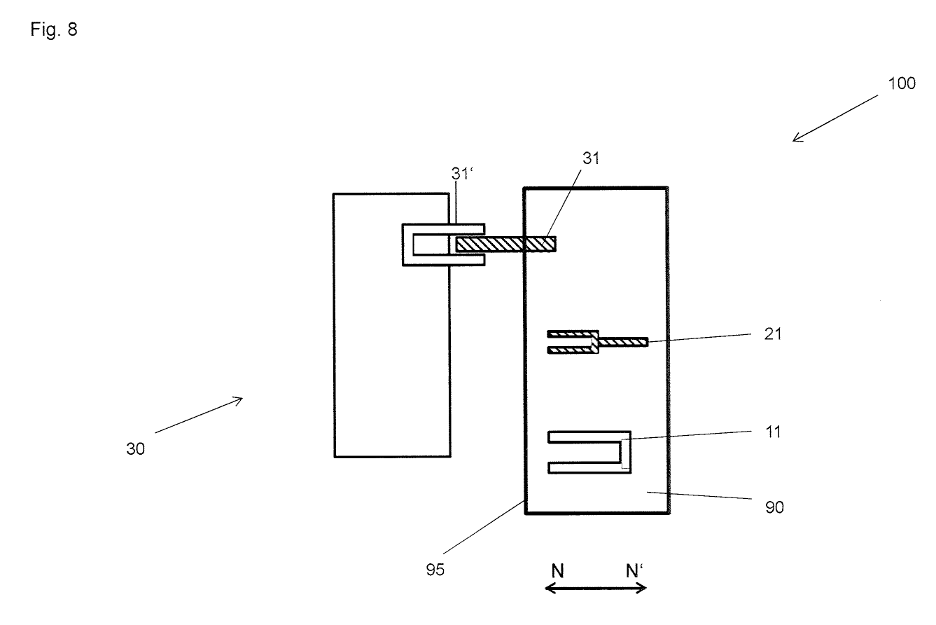

FIG. 8 in turn shows the battery charger 100, and a second secondary charging interface 31, which is configured in the present example as a displaceable blade, in the charging position N and therefore protrudes from the connection side 95 of the charger housing 90. A second secondary tool battery 30 with a second secondary battery interface 31′ can thus be connected to the battery charger 100 and charged. Likewise, since the secondary charging interface 31 in the form of the blade protrudes from the connection side 95 of the charger housing 90, a connection of the main tool battery 10 of FIG. 6 or of the first secondary tool battery 20 of FIG. 7 to the battery charger 100 of FIG. 8 is mechanically locked.

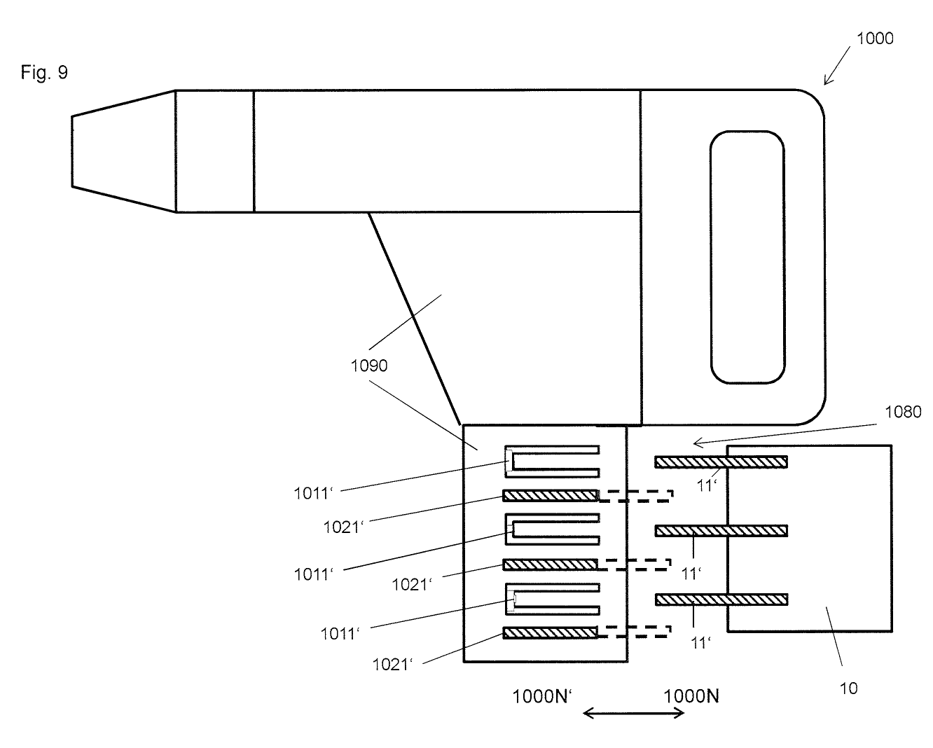

FIG. 9 shows a hand-held machine tool 1000 according to the invention in the form of a jackhammer. The hand-held machine tool 1000 comprises a tool housing 1090 in whose battery receiving recess 1080 is arranged a main supply interface 1011′ in the form of three connection sockets for connecting a main tool battery 10. The main supply interface 1011′ provided in the form of three connection sockets corresponds to a main battery interface 11′ which is provided as three blades protruding rigidly from the main battery 10.

A secondary supply interface 1021′ for connecting a secondary tool battery (not shown), if required, is arranged in the receiving recess 1080, the secondary supply interface is configured displaceably between a supply position 1000N (represented with a dotted line) and a rest position 100ON′ (represented by means of a solid line). Since the secondary supply interface 1021′, as represented, is in the rest position 1000N′, i.e., in the withdrawn position, the main tool battery 10 can be connected to the main supply interface 1011′. This would not be the case if the secondary supply interface 1021′ were in the supply position 1000N (represented with a dotted line), whereby the main supply interface 1011′ would be mechanically locked for the main tool battery 10.

### LIST OF REFERENCE NUMERALS

10 main tool battery

11 main charging interface

11′ main battery interface

21 first secondary charging interface

21′ first secondary battery interface

31 second secondary charging interface

31′ second secondary battery interface

70 charging electronics

71 connection cable

73 sensor

90 charger housing

95 connection side

100 battery charger

1000 hand-held machine tool

1011′ main supply interface

1021′ secondary supply interface

1080 battery receiving recess

1090 tool housing

N charging position

N′ rest position

1000N supply position

1000N′ rest position

P motion path

1.-10. (canceled)

11. A battery charger, comprising:
a charger housing;
a main charging interface disposed on a connection side of the charger housing, wherein a main tool battery of a hand-held machine tool is connectable to the main charging interface; and
a secondary charging interface disposed on the connection side of the charger housing, wherein the secondary charging interface is displaceable between a charging position and a rest position and wherein a secondary tool battery is connectable to the secondary charging interface when the secondary charging interface is in the charging position.

12. The battery charger according to claim 11, wherein the main charging interface is mechanically locked against connection of the main tool battery when the secondary charging interface is in the charging position and the main charging interface is mechanically released for connection of the main tool battery when the secondary charging interface is in the rest position.

13. The battery charger according to claim 11, wherein the main charging interface is a charging socket.

14. The battery charger according to claim 11, wherein the secondary charging interface is a blade which is displaceable between the charging position and the rest position and which protrudes from the connection side of the charger housing in the charging position.

15. The battery charger according to claim 11 further comprising a charging electronics which is disposed inside the charger housing, wherein the charging electronics is configured to charge the main tool battery when connected via the main charging interface with a main charging configuration and to charge the secondary tool battery when connected via the secondary charging interface with a secondary charging configuration.

16. The battery charger according to claim 11 further comprising a sensor, wherein the sensor is configured to sense whether the secondary charging interface is in the charging position or the rest position.

17. The battery charger according to claim 15 further comprising a sensor, wherein the sensor is configured to sense whether the secondary charging interface is in the charging position or the rest position and wherein the charging electronics is configured to switch between the main charging configuration and the secondary charging configuration depending on the sensor.

18. The battery charger according to claim 11, wherein the main charging interface and the secondary charging interface are coded mechanically differently and wherein the main tool battery and the secondary tool battery are different types.

19. A charging system, comprising:
a battery charger according to claim 11;
a main tool battery connectable to the main charging interface; and
a secondary tool battery connectable to the secondary charging interface.

20. A hand-held machine tool, comprising:
a tool housing with a battery receiving recess;
a main supply interface disposed in the battery receiving recess, wherein a main tool battery is connectable to the main supply interface; and
a secondary supply interface disposed in the battery receiving recess, wherein a secondary tool battery is connectable to the secondary supply interface, wherein the secondary supply interface is displaceable between a supply position and a rest position, and wherein the secondary tool battery is connectable to the secondary supply interface when the secondary supply interface is in the supply position.

21. The hand-held machine tool according to claim 20, wherein the hand-held machine tool is a jackhammer or a combination hammer.
